(19) United States
(12) Patent Application Publication
(10) Pub. No.: US 2026/0362386 A1
(43) Pub. Date: Nov. 12, 2026

(54) LOCATION INFORMATION RETRIEVAL IN COMMUNICATION NETWORKS

(71) Applicant: Boost SubscriberCo L.L.C., Englewood, CO (US)

(72) Inventors: Abhishek Jayprakash Shirke, Aurora, CO (US); Brijesh Kumar Mishra, Highlands Ranch, CO (US); Ramakrishna M. Mudumby, Littleton, CO (US); Sruthi Nair, Aurora, CO (US); Dawood Shahdad, Aurora, CO (US)

(21) Appl. No.: 19/205,633

(22) Filed: May 12, 2025

(51) Int. Cl. H04W 64/00; H04W 4/02; H04W 28/02

(52) U.S. Cl. CPC H04W 64/003; H04W 4/025; H04W 28/0268

(57) ABSTRACT

A disclosed method may include (i) receiving, by a Network Exposure Function (NEF), a request from a Lawful Interception System (LIS) to obtain location information for a target subscriber, (ii) transmitting, by the NEF in response to receiving the request, a subscription request to a Unified Data Management (UDM) function such that the UDM function subscribes to location information for the target subscriber, and (iii) identifying, by the UDM function based on the subscription request, a specific Access and Mobility Management Function (AMF) currently serving the target subscriber.

### BRIEF SUMMARY

This disclosure is generally directed to systems, methods, and computer-readable media relating to location information retrieval in communication networks. Location information retrieval in communication networks may present various challenges and opportunities for improvement. As networks evolve and become more complex, the methods for obtaining and managing location data for subscribers may adapt to meet new requirements and expectations. In some scenarios, lawful interception systems may benefit from efficient and accurate location information for target subscribers, which may lead to the development of novel techniques for retrieving and delivering this data within the network infrastructure. These systems may seek to balance the interests of law enforcement agencies with the privacy concerns of subscribers and the technical considerations of existing network architectures. Additionally, the increasing prevalence of mobile devices and the growing demand for location-based services may drive the development of more sophisticated location retrieval mechanisms that can handle large volumes of requests while maintaining low latency and high accuracy.

One potential challenge in location information retrieval may involve the scalability of existing systems. As the number of connected devices continues to grow, some methods of querying individual network elements for location data may become less efficient and more resource-intensive. This issue may be particularly pronounced in scenarios where multiple access and mobility management functions (AMFs) are present in the network, each potentially serving different subsets of subscribers. In such cases, a lawful interception system may query multiple AMFs to locate a specific target subscriber, which may result in increased network traffic, higher latency, and potential inconsistencies in the retrieved information. Furthermore, this technique may not be optimal for handling real-time location tracking or scenarios where subscribers frequently move between different AMF coverage areas. To address these scalability considerations, new approaches may be developed that leverage centralized data management and more efficient query mechanisms to reduce the overall load on the network and improve response times for location requests.

Another area where improvements may be beneficial is in the handling of international roaming scenarios. As subscribers travel across borders and connect to different networks, retrieving accurate location information may become more complex due to the involvement of multiple network operators and potential differences in network architectures or protocols. Some methods of location retrieval may not account for these cross-border scenarios, potentially leading to gaps in coverage or delays in obtaining up-to-date location data for roaming subscribers. Additionally, security considerations may become more pronounced when dealing with international roaming, as sensitive location information may be exchanged between different network operators while maintaining strict privacy and data protection standards. Developing techniques that can seamlessly handle these international roaming cases while ensuring secure and efficient location data retrieval may be an area of focus for improving overall system performance and reliability.

Privacy and security concerns may also present challenges in location information retrieval systems. As location data is inherently sensitive, robust mechanisms may be developed to ensure that only authorized entities can access this information and that it is transmitted and stored securely. This may involve implementing strong authentication protocols, encryption techniques, and/or access control measures throughout the location retrieval process. Additionally, there may be opportunities to balance the interests of lawful interception systems with the privacy rights of subscribers, potentially leading to the development of techniques that can provide accurate location information for legitimate law enforcement purposes while minimizing the risk of unauthorized access or misuse of this data. These privacy and security considerations may become even more significant as location-based services become more prevalent and the volume of location data being generated and transmitted across networks continues to increase.

To address these challenges, techniques for location information retrieval in communication networks may be developed. One potential solution may involve the use of a centralized network exposure function (NEF) as a single point of contact for lawful interception systems seeking location information. This technique may allow the NEF to act as an intermediary between the lawful interception system and the core network components, streamlining the process of obtaining location data and reducing the number of queries to individual AMFs. By leveraging the NEF, the system may be able to more efficiently determine which specific AMF is currently serving a target subscriber, potentially improving response times and reducing overall network load. This centralized technique may also provide a more consistent and standardized interface for location requests, simplifying integration with lawful interception systems and potentially improving interoperability across different network configurations.

Unified data management (UDM) functions may play a role in managing subscriber information within communication networks. In some implementations, a UDM may store and maintain information about which Access and Mobility Management Function (AMF) is currently serving each subscriber. This centralized approach to storing subscriber-AMF associations may offer certain advantages in location information retrieval scenarios. For instance, when a location request is received, the system may leverage the UDM to quickly identify the specific AMF currently serving the target subscriber. This technique may potentially streamline the process of directing location requests to the appropriate AMF, which may be particularly beneficial in scenarios where subscribers move between different AMF coverage areas. By utilizing the UDM in this manner, the system may achieve more efficient tracking of subscriber locations and potentially reduce instances of outdated or incorrect information being returned. Furthermore, the UDM's role in storing subscriber data may allow for the provision of additional relevant information alongside location data, which may enable more comprehensive and context-aware location services in some implementations.

Enhancements to the subscription-based model for location information retrieval may also be developed to improve system efficiency and flexibility. These techniques may allow lawful interception systems to specify different types of location reporting, such as one-time queries, periodic updates, or event-driven notifications. By providing more granular control over the frequency and type of location information provided, these subscription-based models may help to reduce unnecessary network traffic and ensure that lawful interception systems receive the most relevant and timely data for their specific interests. Additionally, these subscription models may incorporate features such as maximum report limits or expiration times, allowing for better management of system resources and helping to prevent potential misuse or overuse of location tracking capabilities.

In some examples, a method includes (i) receiving, by a Network Exposure Function (NEF), a request from a Lawful Interception System (LIS) to obtain location information for a target subscriber, (ii) transmitting, by the NEF in response to receiving the request, a subscription request to a Unified Data Management (UDM) function such that the UDM function subscribes to location information for the target subscriber, (iii) identifying, by the UDM function based on the subscription request, a specific Access and Mobility Management Function (AMF) currently serving the target subscriber, (iv) informing, by the UDM function, the identified specific AMF of the subscription request, (v) receiving, by the NEF from the identified specific AMF and in response to informing the identified specific AMF, location information for the target subscriber, and (vi) providing, by the NEF, the received location information to the LIS.

In some examples, the method further comprises authenticating the LIS using a bearer token.

In some examples, the subscription request comprises a service-based interface using HTTP or HTTPS protocols.

In some examples, the location information comprises one of current location, last known location, deferred location, or periodic location reporting.

In some examples, the method further comprises determining that the target subscriber is in an idle state such that the AMF provides last known location information.

In some examples, the UDM function updates the specific AMF whenever the target subscriber registers with a different AMF.

In some examples, the subscription request specifies a maximum number of location reports such that the subscription is terminated when the maximum number is reached.

In some examples, the location information comprises one of Cell Global Identity (CGI) or Evolved CGI (E-CGI).

In some examples, the method further comprises encrypting communications between the NEF and the LIS using Transport Layer Security (TLS).

In some examples, the subscription request specifies continuous location reporting for the target subscriber.

In some examples, the NEF integrates with the LIS using a 3GPP-defined Application Programming Interface (API).

In some examples, the method is performed in a 5G or subsequent generation network.

In some examples, the method is performed in a 5G network.

In some examples, the method further comprises providing location information for an international roaming scenario through a Security Edge Protection Proxy (SEPP).

In some examples, the method further comprises paging the target subscriber such that current location information is obtained in response to the target subscriber being in an idle state.

In some examples, the UDM function: stores an International Mobile Subscriber Identity (IMSI) for the target subscriber or stores a subscription detail comprising at least one of allowed service, Quality of Service (QoS) parameter, or access restriction.

In some examples, a non-transitory computer-readable medium has instructions stored thereon that, when executed by at least one physical computing processor, cause a computing device to perform operations comprising (i) receiving, by a Network Exposure Function (NEF), a request from a Lawful Interception System (LIS) to obtain location information for a target subscriber, (ii) transmitting, by the NEF in response to receiving the request, a subscription request to a Unified Data Management (UDM) function such that the UDM function subscribes to location information for the target subscriber, (iii) identifying, by the UDM function based on the subscription request, a specific Access and Mobility Management Function (AMF) currently serving the target subscriber, (iv) informing, by the UDM function, the identified specific AMF of the subscription request, (v) receiving, by the NEF from the identified specific AMF and in response to informing the identified specific AMF, location information for the target subscriber, and (vi) providing, by the NEF, the received location information to the LIS.

In some examples, a system comprises at least one physical computing processor of a computing device and a non-transitory computer-readable medium that has instructions stored thereon that, when executed by the at least one physical computing processor, cause the computing device to perform operations comprising (i) receiving, by a Network Exposure Function (NEF), a request from a Lawful Interception System (LIS) to obtain location information for a target subscriber, (ii) transmitting, by the NEF in response to receiving the request, a subscription request to a Unified Data Management (UDM) function such that the UDM function subscribes to location information for the target subscriber, (iii) identifying, by the UDM function based on the subscription request, a specific Access and Mobility Management Function (AMF) currently serving the target subscriber, (iv) informing, by the UDM function, the identified specific AMF of the subscription request, (v) receiving, by the NEF from the identified specific AMF and in response to informing the identified specific AMF, location information for the target subscriber, and (vi) providing, by the NEF, the received location information to the LIS.

### BRIEF DESCRIPTION OF THE DRAWINGS

For a better understanding of the present invention, reference will be made to the following Detailed Description, which is to be read in association with the accompanying drawings:

FIG. 1 shows an example flow diagram for a method relating to location information retrieval in communication networks.

FIG. 2 illustrates a system diagram comparing related and improved techniques for lawful interception location queries.

FIG. 3 depicts a network architecture diagram showcasing components involved in efficient location information retrieval.

FIG. 4 presents a timing diagram illustrating the message flow for subscribing to and notifying of location events in a 5G mobile network.

FIG. 5 shows a timing diagram depicting message flow for monitoring requests and responses in a related 4G network architecture.

FIG. 6 illustrates various aspects of the improved location information retrieval process through multiple scenarios.

FIG. 7 presents a detailed schematic diagram of the lawful interception location tracking process in a 5G mobile network.

FIG. 8 shows a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

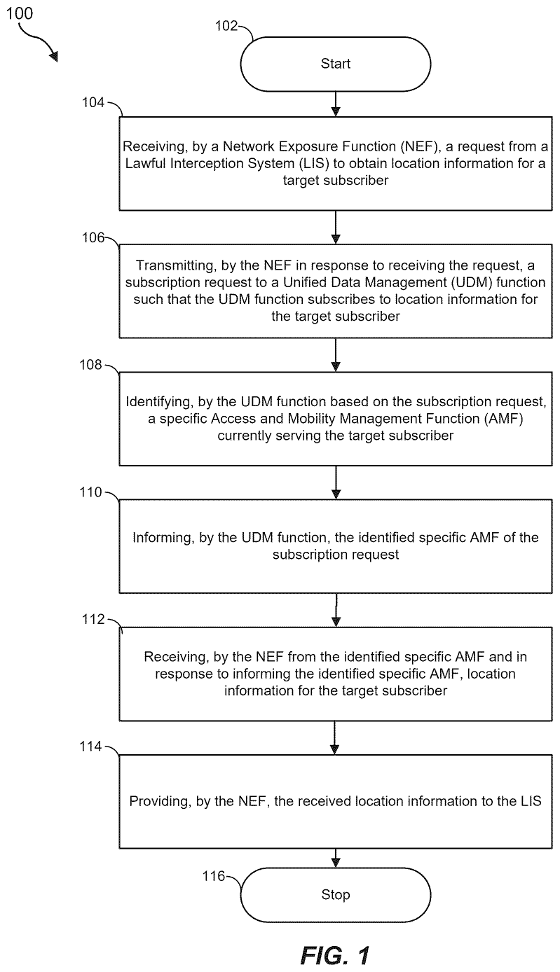

FIG. 1 shows a flow diagram for a method 100 relating to location information retrieval in communication networks. At step 102, method 100 may start. At step 104, method 100 includes receiving, by a Network Exposure Function (NEF), a request from a Lawful Interception System (LIS) to obtain location information for a target subscriber. At step 106, method 100 includes transmitting, by the NEF in response to receiving the request, a subscription request to a Unified Data Management (UDM) function such that the UDM function subscribes to location information for the target subscriber. At step 108, method 100 includes identifying, by the UDM function based on the subscription request, a specific Access and Mobility Management Function (AMF) currently serving the target subscriber. At step 110, method 100 includes informing, by the UDM function, the identified specific AMF of the subscription request. At step 112, method 100 includes receiving, by the NEF from the identified specific AMF and in response to informing the identified specific AMF, location information for the target subscriber. At step 114, method 100 includes providing, by the NEF, the received location information to the LIS. At step 116, method 100 ends.

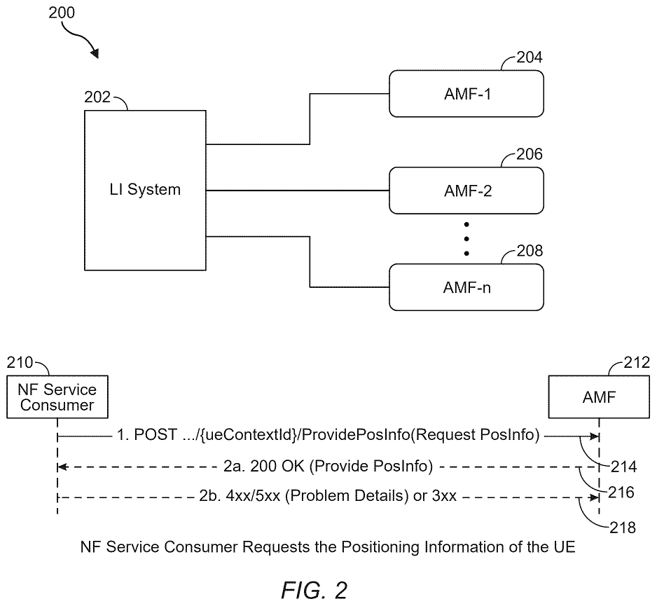

FIG. 2 shows an example system diagram 200 illustrating a technique for lawful interception location queries in communication networks. The diagram depicts two aspects of the same technique, illustrating both the overall system architecture and the detailed messaging process. In the upper portion of the diagram, a Lawful Interception (LI) system 202 is shown connected to multiple Access and Mobility Management Functions (AMFs), specifically AMF-1 204, AMF-2 206, and AMF-n 208. This configuration illustrates a scenario where the LI system 202 may query multiple AMFs to obtain location information for a target subscriber. In this arrangement, the LI system 202 may not have prior knowledge of which specific AMF is currently serving the target subscriber, which may lead to multiple queries being sent to different AMFs in an attempt to locate the subscriber's information. This aspect of the technique may involve increased network traffic and longer response times as the system searches for the correct AMF holding the desired location data. In some examples, this method may be helpful in situations where direct knowledge of the serving AMF is not available or when a comprehensive search across multiple AMFs is desired for thoroughness.

The lower section of FIG. 2 provides a detailed view of the messaging process that occurs between the LI system (represented here as a Network Function (NF) Service Consumer 210) and a single AMF 212. This part of the diagram focuses on the communication flow for a single location information request, which would be repeated for each AMF in the upper portion of the diagram. The NF Service Consumer 210 interacts with the AMF 212 through a series of standardized messages. The diagram shows three specific message exchanges between the NF Service Consumer 210 and the AMF 212. The first message 214 depicts a POST request with the notation “1. POST . . . /{ueContextId}/ProvidePosInfo(Request PosInfo),” which indicates a request for position information for a specific user equipment (UE) context. This message initiates the location query process for a particular subscriber. The second message 216 shows a response “2a. 200 OK (Provide PosInfo),” indicating that the AMF 212 has successfully provided the requested position information. This response would occur when the queried AMF is indeed the one serving the target subscriber and has the location information available. The third message 218 illustrates potential error responses “2b. 4xx/5xx (Problem Details) or 3xx,” which may occur if there are issues with processing the request or if a redirection is necessary. These error responses may be received when the queried AMF is not the one serving the target subscriber or if there are other issues in retrieving the location information.

The combination of the upper and lower portions of FIG. 2 provides a comprehensive view of this location information retrieval technique. The upper portion illustrates the potential need for multiple queries to different AMFs, while the lower portion details the specific messaging that occurs for each of these queries. This technique may involve the LI system 202 sending the request shown in message 214 to each of the AMFs (204, 206, 208) sequentially or in parallel. The system may then wait for a successful response (message 216) from one of the AMFs, indicating that the correct serving AMF has been found and the location information has been retrieved. Error responses (message 218) from AMFs not serving the target subscriber would be ignored or used to trigger queries to additional AMFs. This process may continue until the desired location information is obtained or all available AMFs have been queried.

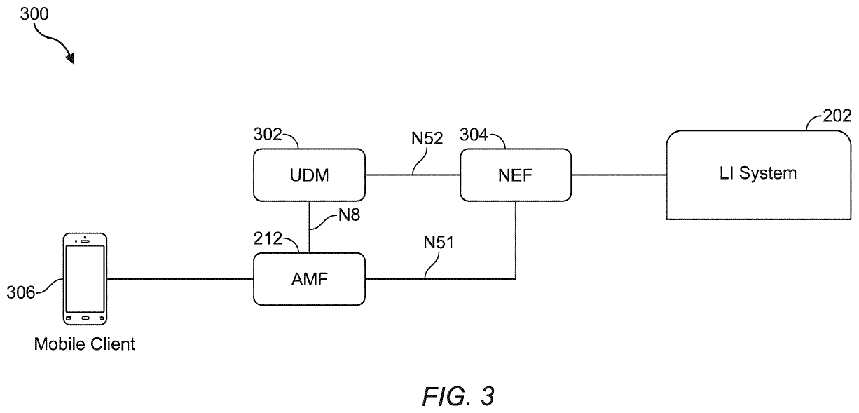

FIG. 3 shows an example network architecture diagram illustrating an improved technique for location information retrieval in communication networks. The diagram depicts components involved in the process of obtaining location data for lawful interception purposes, presenting an improved method compared to the technique shown in FIG. 2. In this configuration, a mobile client 306 is connected to an Access and Mobility Management Function (AMF) 212, which serves as the primary point of contact for the mobile device within the network. The AMF 212 may play a centralized role in managing the mobility and connectivity of the mobile client 306, and may maintain current location information for the device. This arrangement may allow for more efficient handling of location requests, as the AMF 212 may have direct access to the most up-to-date position data for the mobile client 306. In some examples, the AMF 212 may utilize various positioning methods to determine the location of the mobile client 306, which may include cell-based positioning, GPS data, or other location-determination techniques. The direct connection between the mobile client 306 and the AMF 212 may also facilitate faster updates of location information as the device moves within the network coverage area.

The diagram illustrates several interconnections between network components, each serving a specific purpose in the location retrieval process. An N8 connection is shown between the AMF 212 and a Unified Data Management (UDM) function 302. This connection may be used for exchanging subscriber-related information, including updates about the current serving AMF for a particular subscriber. The UDM 302 may act as a centralized repository for subscriber data, potentially streamlining the process of locating the correct AMF for a given target subscriber. In some examples, the UDM 302 may maintain a dynamic mapping of subscribers to their current serving AMFs, which may be updated in real-time as mobile clients move between different AMF coverage areas. This centralized approach may significantly reduce the time and network resources required to locate a specific subscriber, as it eliminates the need for querying multiple AMFs individually. Additionally, the UDM 302 may store other relevant subscriber information, such as subscription details, quality of service parameters, and/or access restrictions, which may be helpful in the context of lawful interception requests.

A lateral N52 connection is depicted between the UDM 302 and a Network Exposure Function (NEF) 304. This connection may facilitate the exchange of information between the core network components and external systems, such as the Lawful Interception (LI) System 202. The NEF 304 may serve as an intermediary, exposing network capabilities and subscriber information in a controlled and secure manner. In some scenarios, the NEF 304 may implement various security measures, such as authentication mechanisms, encryption protocols, and/or access control policies, to help ensure that only authorized external systems can access sensitive subscriber information. The N52 connection may allow the NEF 304 to query the UDM 302 for subscriber-related data, including the identity of the current serving AMF, without directly exposing the UDM 302 to external systems. This layered approach may enhance the overall security of the network architecture while still providing the necessary functionality for lawful interception purposes.

Additionally, a right-angle N51 connection is shown going from the AMF 212 to the NEF 304. This direct connection between the AMF and NEF may allow for efficient transfer of location information once the correct serving AMF has been identified. In some examples, when the NEF 304 receives a location request from the LI System 202, it may first query the UDM 302 to determine which AMF is currently serving the target subscriber. Once this information is obtained, the NEF 304 may then use the N51 connection to directly request the location data from the appropriate AMF 212. This direct communication path may reduce latency in the location retrieval process, as it bypasses the need for routing requests through multiple network components. The N51 connection may also support various types of location reporting, such as one-time queries, periodic updates, and/or event-driven notifications, providing flexibility in how location information is obtained and delivered to the LI System 202.

The rightmost component in the diagram is the LI System 202, which is connected to the NEF 304. This connection represents the interface through which lawful interception requests may be made and location information may be delivered. By interfacing with the NEF 304 rather than directly with multiple AMFs (as shown in FIG. 2), the LI System 202 may benefit from a more streamlined and efficient process for obtaining location data. In some scenarios, the communication between the LI System 202 and the NEF 304 may be secured using various methods, such as Transport Layer Security (TLS) protocols, bearer tokens for authentication, and/or other encryption techniques. These security measures may help protect the confidentiality and integrity of the lawful interception requests and the resulting location data.

The architecture depicted in FIG. 3 may offer several potential advantages over the technique illustrated in FIG. 2. Firstly, the centralized role of the UDM 302 in maintaining subscriber-AMF associations may eliminate the need for the LI System to query multiple AMFs to locate a target subscriber. Instead, the UDM 302 may directly inform the NEF 304 which AMF is currently serving the subscriber of interest. This could significantly reduce network traffic and improve response times for location queries. Secondly, the use of the NEF 304 as an intermediary may provide an additional layer of security and abstraction between the external LI System and the core network components. This may allow for better control over what information is exposed and how it is accessed. Thirdly, the direct N51 connection between the AMF 212 and the NEF 304 may enable faster transfer of location data once the correct AMF has been identified, potentially reducing overall latency in the location retrieval process.

In some examples, the unified data management function may update the specific access and mobility management function whenever the target subscriber registers with a different access and mobility management function. This dynamic updating process may be implemented through various mechanisms within the network architecture shown in FIG. 3. The Unified Data Management (UDM) function 302 may maintain a real-time database of subscriber-AMF associations. When a mobile client 306 moves between coverage areas and registers with a new AMF 212, the UDM 302 may receive a notification. The UDM 302 may then update its internal records and propagate this information to relevant network components. In some scenarios, the UDM 302 may employ a publish-subscribe model where interested network functions may register to receive updates about specific subscribers or groups of subscribers. The system may also implement a tiered update mechanism where critical changes are broadcast immediately while less urgent updates are batched and sent periodically to reduce network traffic. The UDM 302 may utilize adaptive algorithms to predict likely AMF transitions based on subscriber movement patterns and proactively prepare for handovers. In complex network environments, the UDM 302 may maintain multiple AMF associations for a single subscriber, each serving different network slices or services. The update process may include versioning and timestamping to help resolve conflicts in distributed systems. Additionally, the UDM 302 may implement a caching layer to store frequently accessed AMF associations. This cache may be distributed across multiple network nodes to improve access times and resilience. The system may also support bulk updates for scenarios involving mass subscriber migrations, such as during network maintenance or disaster recovery operations. To enhance privacy and security, the UDM 302 may employ encryption and access control mechanisms when distributing AMF association updates. The update process may be integrated with load balancing functions, allowing the UDM 302 to suggest optimal AMF assignments based on current network conditions. In some implementations, the UDM 302 may maintain a historical log of AMF associations, enabling network operators to analyze subscriber mobility patterns and optimize network resources. The system may also support partial updates where only changed fields are transmitted, reducing bandwidth usage. For international roaming scenarios, the UDM 302 may coordinate with visited network UDMs to maintain accurate AMF associations across network boundaries. The update mechanism may be designed with fault tolerance in mind, incorporating redundancy and fallback procedures to handle communication failures between network components. By continuously refining and adapting the AMF update process, the system may improve the efficiency and reliability of location information retrieval for lawful interception purposes.

In some examples, the unified data management function may store an International Mobile Subscriber Identity (IMSI) for the target subscriber or store a subscription detail comprising at least one of allowed service, Quality of Service (QoS) parameter, or access restriction. The Unified Data Management (UDM) function 302 in FIG. 3 may implement various storage and management techniques for subscriber information. The UDM 302 may utilize a distributed database architecture to store IMSIs and subscription details across multiple physical or virtual nodes. This distributed approach may improve data access speeds and system resilience. The storage system may employ advanced indexing techniques to facilitate rapid IMSI lookups. In some scenarios, the UDM 302 may implement a hierarchical storage model where frequently accessed data, such as IMSIs, is kept in high-speed memory while detailed subscription information is stored in lower-cost, higher-capacity storage. The system may also support dynamic data partitioning based on factors like subscriber location or network slice to optimize data retrieval times. For enhanced security, the UDM 302 may encrypt stored IMSIs and subscription details using robust encryption algorithms. Access to this sensitive information may be controlled through multi-factor authentication and role-based access control systems. The UDM 302 may also implement a versioning system for subscription details. This may allow for tracking changes over time and support rollback capabilities if needed. In terms of subscription details, the system may use a flexible schema that allows for easy addition or modification of parameters without requiring database restructuring. The UDM 302 may support real-time updates to QoS parameters. This capability may enable dynamic service adjustments based on network conditions or subscriber preferences. For access restrictions, the system may implement a rule-based engine that can interpret complex restriction policies and apply them in real-time. The UDM 302 may also maintain historical records of subscriber service usage and QoS experiences. This data may be used for trend analysis and service improvement. In some implementations, the UDM 302 may support federated storage systems. This may allow for efficient data sharing between home and visited networks in roaming scenarios. The system may also implement advanced caching mechanisms to reduce latency in accessing frequently used subscriber data. For disaster recovery purposes, the UDM 302 may maintain geographically dispersed backups of all subscriber data. These backups may be continuously synchronized to minimize data loss in case of system failures. The UDM 302 may also support bulk data operations for efficient handling of large-scale subscriber management tasks. This capability may be particularly useful during network upgrades or when integrating acquired subscriber bases.

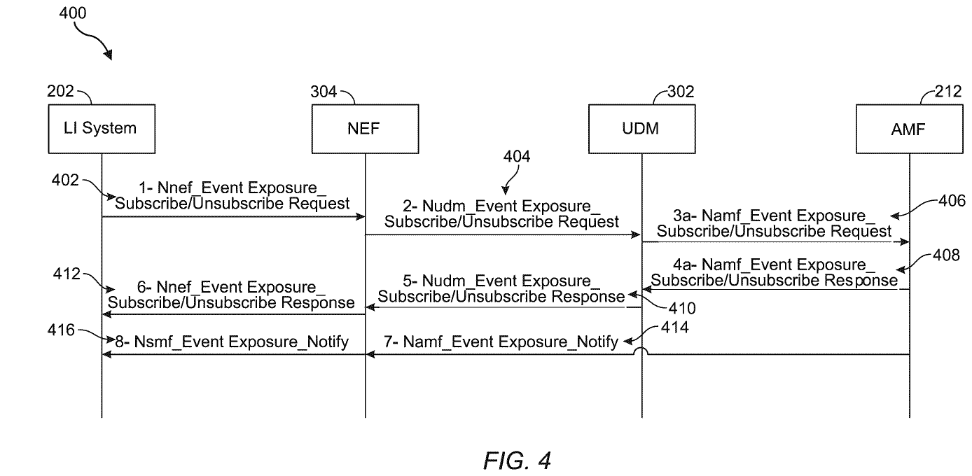

FIG. 4 shows an example timing diagram 400 illustrating the message flow between various network components for subscribing to and notifying of events in a location information retrieval system. The diagram depicts interactions between four components: a Lawful Interception (LI) System 202, a Network Exposure Function (NEF) 304, a Unified Data Management (UDM) function 302, and an Access and Mobility Management Function (AMF) 212. This sequence of messages represents a technique for obtaining and delivering location information for lawful interception purposes in a mobile network environment.

The diagram begins with step 402, which shows a message from the LI System 202 to the NEF 304 labeled “1—Nnef_Event Exposure_Subscribe/Unsubscribe Request”. This initial communication may represent the LI System's request to subscribe to location events for a specific target subscriber. The use of a subscription model may allow for more flexible and efficient handling of location information requests, as it may enable continuous monitoring or periodic updates without the need for repeated individual queries. In some scenarios, this subscription request may include parameters such as the target subscriber's identifier, the type of location information desired, the frequency of updates, and/or any specific conditions under which location information should be provided. The NEF 304 may act as the primary interface for external systems like the LI System 202, providing a standardized and secure method for accessing network capabilities and subscriber information.

Following the initial request, step 404 shows the NEF 304 forwarding a similar request to the UDM 302, labeled “2—Nudm_Event Exposure_Subscribe/Unsubscribe Request”. This step may indicate that the NEF 304 is relaying the subscription request to the UDM 302, which may have more detailed information about the subscriber and their current network status. The UDM 302 may play a helpful role in managing subscriber data and may be responsible for determining which AMF is currently serving the target subscriber. In some examples, this step may involve the UDM 302 checking its internal databases to verify the subscriber's information and identifying the appropriate AMF to handle the location tracking.

The next step in the sequence, step 406, shows a message from the UDM 302 to the AMF 212 labeled “3a—Namf_Event Exposure_Subscribe/Unsubscribe Request”. This communication represents the UDM 302 forwarding the subscription request to the specific AMF 212 that is currently serving the target subscriber. The AMF 212 may be responsible for managing the mobile client's connectivity and may have direct access to the most up-to-date location information. By directing the request to the correct AMF, the system may avoid the inefficiency of querying multiple AMFs, as was potentially necessary in previous techniques. In some scenarios, this step may also involve the AMF 212 setting up internal processes to track the subscriber's location according to the parameters specified in the original subscription request.

Step 408 in the diagram shows a response from the AMF 212 back to the UDM 302, labeled “4a—Namf_Event Exposure_Subscribe/Unsubscribe Response”. This message may indicate that the AMF 212 has successfully processed the subscription request and is prepared to provide location information as specified. The response may include confirmation of the subscription details, any limitations or modifications to the requested parameters, and/or an initial set of location data if immediately available. In some examples, this step may also involve the AMF 212 confirming that it has the necessary resources and permissions to fulfill the location tracking request for the specified subscriber.

The diagram continues with step 410, showing a message from the UDM 302 to the NEF 304 labeled “5—Nudm_Event Exposure_Subscribe/Unsubscribe Response”. This communication may represent the UDM 302 relaying the successful subscription confirmation back through the network hierarchy. The UDM 302 may aggregate any additional information or metadata relevant to the subscription before passing it to the NEF 304. In some scenarios, this step may also involve the UDM 302 updating its internal records to reflect the active subscription, which may be helpful for managing multiple concurrent location tracking requests across the network.

Step 412 depicts the final confirmation message in the subscription process, from the NEF 304 to the LI System 202, labeled “6—Nnef_Event Exposure_Subscribe/Unsubscribe Response”. This message may provide the LI System 202 with confirmation that its subscription request has been successfully processed and that location information will be provided according to the specified parameters. The response may include details such as a subscription identifier, the expected format of location data, and/or any relevant security tokens or authentication information for future communications related to this subscription.

The last two steps in the diagram, 414 and 416, illustrate the actual delivery of location information once the subscription is active. Step 414 shows a message from the AMF 212 to the NEF 304 labeled “7—Namf_Event Exposure_Notify”, which may represent the AMF 212 sending updated location information for the target subscriber. This notification may be triggered by various events, such as the subscriber moving to a new location, a periodic update interval being reached, and/or specific conditions defined in the subscription request being met. In some examples, this step may involve the AMF 212 formatting the location data according to standardized protocols to help ensure compatibility and ease of processing by the receiving systems.

Finally, step 416 shows the NEF 304 forwarding the location information to the LI System 202 with a message labeled “8—Nsmf_Event Exposure_Notify”. This last step in the sequence may represent the delivery of the requested location data to the LI System 202, completing the information flow from the network to the requesting entity. The NEF 304 may perform additional processing on the data before forwarding it, such as applying any necessary security measures, formatting the information according to the agreed-upon interface specifications, and/or adding any relevant metadata or context information that may be helpful for the LI System 202 in interpreting and utilizing the location data.

In some examples, the subscription request may comprise a service-based interface using HTTP or HTTPS protocols. This service-based interface may be implemented in various ways within the network architecture depicted in FIG. 4. The Network Exposure Function (NEF) 304 may act as the primary point of interaction for external systems like the Lawful Interception (LI) System 202, offering a RESTful API that adheres to HTTP or HTTPS standards. This API may support a wide range of operations beyond simple subscription requests. It may include endpoints for query parameters, allowing requestors to specify complex criteria for subscriber selection. The interface may also offer batch subscription capabilities, enabling multiple target subscribers to be monitored with a single request. In some implementations, the NEF 304 may provide a GraphQL interface alongside traditional REST, offering more flexibility in data querying and reducing over-fetching of information. The service-based interface may incorporate WebSocket protocols for real-time updates, complementing the request-response model of HTTP. This may be particularly useful for continuous location tracking scenarios. The NEF 304 may implement content negotiation mechanisms, allowing clients to specify preferred data formats such as JSON, XML, or Protocol Buffers. For enhanced security, the interface may support mutual TLS authentication in addition to standard HTTPS encryption. The NEF 304 may also offer a discovery mechanism, publishing its capabilities and endpoints through a standardized format that clients can dynamically consume. Rate limiting and quota management features may be built into the interface to prevent abuse and ensure fair resource allocation among multiple LI systems. The service-based interface may support versioning, allowing for backwards compatibility as new features are added. This may be achieved through URL versioning or custom headers. In some scenarios, the NEF 304 may implement a facade pattern, presenting a simplified interface to external systems while managing the complexity of interactions with internal network functions like the Unified Data Management (UDM) function 302. The interface may also support long-polling or server-sent events as alternatives to WebSockets for scenarios where persistent connections are not feasible. Error handling in the interface may be standardized, with well-defined error codes and descriptive messages to facilitate troubleshooting. The NEF 304 may also provide a sandbox environment for testing and integration, allowing LI systems to validate their implementations without affecting live network operations.

In some examples, the subscription request may specify a maximum number of location reports such that the subscription is terminated when the maximum number is reached. This feature may be implemented in various ways within the location information retrieval system depicted in FIG. 4. The Network Exposure Function (NEF) 304 may incorporate a counter mechanism that tracks the number of location reports generated for each subscription. This counter may be incremented with each notification sent to the Lawful Interception (LI) System 202, as shown in step 416. The system may allow for flexible configuration of the maximum report number, which may be set on a per-subscription basis or globally for all requests from a particular LI System 202. In some scenarios, the NEF 304 may implement a sliding window technique where the maximum number applies to a specific time frame, resetting periodically to allow for ongoing monitoring while still limiting the total number of reports. The system may also support dynamic adjustment of the maximum report number based on factors such as network load, time of day, or subscriber behavior patterns. The NEF 304 may offer an API endpoint for LI Systems to query the current report count and remaining allocation for active subscriptions. In cases where multiple subscribers are monitored under a single subscription, the system may implement individual counters for each target while maintaining an overall maximum for the subscription. The NEF 304 may provide options for graceful termination of subscriptions, such as sending a final summary report or allowing a cool-down period where a limited number of additional reports may be generated. To prevent abrupt termination of monitoring, the system may implement a warning mechanism that notifies the LI System 202 when the report count approaches the specified maximum. This may allow for timely renewal or extension of the subscription if needed. The NEF 304 may also support conditional maximum report numbers, where the limit may be automatically increased or removed based on predefined triggers or events of interest. For auditing and compliance purposes, the system may maintain detailed logs of report counts and subscription terminations, which may be made available to authorized entities for review. In scenarios involving multiple network functions, as shown in FIG. 4, the NEF 304 may coordinate with the Unified Data Management (UDM) function 302 and Access and Mobility Management Function (AMF) 212 to ensure consistent application of report limits across the network.

In some examples, the subscription request may specify continuous location reporting for the target subscriber. This continuous reporting feature may be implemented through various mechanisms within the network architecture shown in FIG. 4. The Network Exposure Function (NEF) 304 may offer configurable reporting intervals, ranging from near real-time updates to periodic reports at longer intervals. The system may support adaptive reporting frequencies that automatically adjust based on the subscriber's movement patterns or network conditions. For instance, the reporting interval may shorten when the target subscriber is moving rapidly and lengthen during periods of inactivity. The NEF 304 may implement a push-based notification system where location updates are sent to the Lawful Interception (LI) System 202 as soon as they are available, minimizing latency in the reporting process. Alternatively, the system may use a pull-based model where the LI System 202 periodically requests updates, allowing for better control over the timing of information retrieval. The continuous reporting mechanism may incorporate geofencing capabilities, triggering more frequent updates when the target subscriber enters or exits predefined areas of interest. The system may also support multi-level reporting, where basic location information is provided continuously, with more detailed data available on-demand or triggered by specific events. To manage network resources effectively, the NEF 304 may implement intelligent batching of location updates, aggregating multiple reports into a single transmission when appropriate. The continuous reporting feature may include options for temporal filtering, allowing the LI System 202 to specify time windows of interest and receive updates only during those periods. The system may offer fallback mechanisms for scenarios where continuous reporting is temporarily unavailable, such as when the target subscriber enters areas with limited network coverage. In such cases, the system may store location updates locally and transmit them in bulk when connectivity is restored. The NEF 304 may provide APIs for dynamically adjusting the parameters of continuous reporting, allowing the LI System 202 to modify the reporting behavior based on evolving operational needs. To enhance privacy and security, the system may implement granular access controls and audit trails for continuous location reporting, ensuring that only authorized entities can initiate and maintain such subscriptions. The continuous reporting feature may also include built-in redundancy and failover mechanisms to help ensure uninterrupted location tracking even in the event of partial network outages.

In some examples, the network exposure function may integrate with the lawful interception system using a 3GPP-defined Application Programming Interface (API). This integration may be implemented through various mechanisms within the network architecture shown in FIG. 4. The Network Exposure Function (NEF) 304 may offer a standardized interface that adheres to 3GPP specifications, allowing for consistent communication between the NEF 304 and the Lawful Interception (LI) System 202. This API may support a wide range of operations, including subscription management, location queries, and/or event notifications. The NEF 304 may implement versioning in its API to support backward compatibility while allowing for the introduction of new features. This versioning may be handled through URL paths, custom headers, or content negotiation techniques. The API may offer different levels of access based on the authentication and authorization of the LI System 202. These access levels may determine the granularity of location information provided and/or the types of operations allowed. The NEF 304 may support bulk operations through its API, enabling the LI System 202 to manage multiple subscriptions or query multiple subscribers in a single request. This may improve efficiency in scenarios involving large-scale monitoring. The API may include rate limiting and throttling mechanisms to prevent abuse and help ensure fair resource allocation among multiple LI systems. These limits may be dynamically adjusted based on network conditions and/or prioritization of certain types of requests. The NEF 304 may offer a discovery mechanism as part of its API, allowing the LI System 202 to dynamically learn about available capabilities and endpoints. This may facilitate easier integration and adaptation to changes in the network environment. The API may support different data formats for requests and responses, such as JSON, XML, and/or Protocol Buffers. This flexibility may allow the LI System 202 to choose the most suitable format for its processing needs. The NEF 304 may implement webhooks or callback mechanisms in its API, enabling push-based notifications for events of interest. This may reduce the need for constant polling and improve the timeliness of information delivery. The API may include comprehensive error handling and reporting, providing detailed information about any issues encountered during request processing. This may aid in troubleshooting and improving the reliability of the integration. The NEF 304 may offer a sandbox or test environment for its API, allowing LI System developers to experiment with and validate their implementations without affecting live network operations.

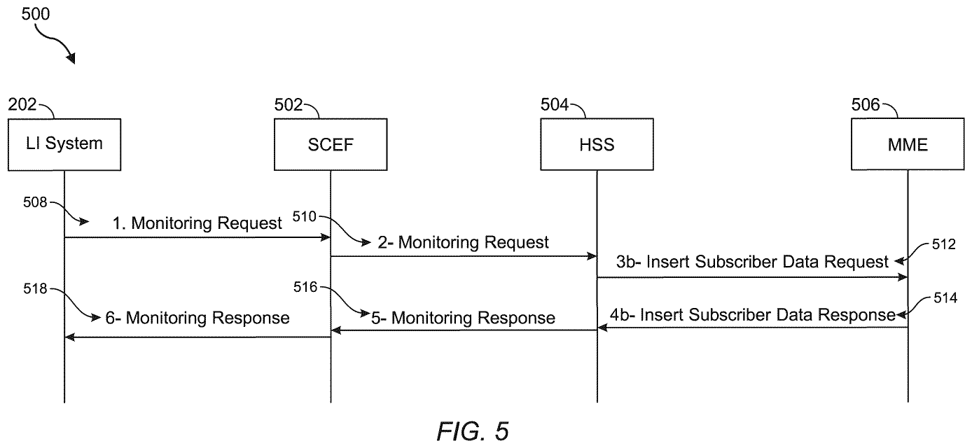

FIG. 5 shows an example timing diagram illustrating a technique for monitoring and retrieving location information in a 4G mobile network environment. The diagram depicts interactions between key components: a Lawful Interception (LI) System 202, a Service Capability Exposure Function (SCEF) 502, a Home Subscriber Server (HSS) 504, and a Mobility Management Entity (MME) 506. This sequence of messages represents a method for efficiently obtaining and delivering location information for lawful interception purposes, which may be implemented in certain network configurations or as part of a broader location tracking system.

The diagram begins with step 508, which shows a message from the LI System 202 to the SCEF 502 labeled “1. Monitoring Request”. This initial communication may represent the LI System's request to start monitoring the location of a specific target subscriber. In some scenarios, this monitoring request may include parameters such as the target subscriber's identifier, the type of location information desired, the frequency of updates, and/or any specific conditions under which location information should be provided. The SCEF 502 may act as an intermediary between external systems like the LI System 202 and the core network components, providing a standardized and secure method for accessing network capabilities and subscriber information. This interface may help maintain a separation between external requests and internal network operations, potentially enhancing security and simplifying integration with various lawful interception systems.

Following the initial request, step 510 shows the SCEF 502 forwarding a similar request to the HSS 504, also labeled “2. Monitoring Request”. This step may indicate that the SCEF 502 is relaying the monitoring request to the HSS 504, which may have more detailed information about the subscriber and their current network status. The HSS 504 may play a central role in managing subscriber data and may be responsible for determining which network elements are currently serving the target subscriber. In some examples, this step may involve the HSS 504 checking its internal databases to verify the subscriber's information and identifying the appropriate MME to handle the location tracking. The use of the HSS 504 in this process may allow for more efficient routing of location requests, as it may have up-to-date information on the subscriber's network attachment point.

The next step in the sequence, step 512, shows a message from the HSS 504 to the MME 506 labeled “3b—Insert Subscriber Data Request”. This communication may represent the HSS 504 instructing the MME 506 to update or insert data related to the monitoring request for the specific subscriber. The MME 506 may be responsible for managing the mobile client's mobility and may have access to the most current location information. By directing the request to the correct MME, the system may avoid the inefficiency of querying multiple network elements, as may be necessary in some other techniques. In some scenarios, this step may also involve the MME 506 setting up internal processes to track the subscriber's location according to the parameters specified in the original monitoring request. The use of “3b” in the step label may suggest that this is part of a sub-sequence or an alternative flow within the main process, potentially indicating flexibility in how subscriber data is managed across different network configurations or scenarios.

Step 514 in the diagram shows a response from the MME 506 back to the HSS 504, labeled “4b—Insert Subscriber Data Response”. This message may indicate that the MME 506 has successfully processed the subscriber data insertion request and is prepared to provide location information as specified. The response may include confirmation of the monitoring details, any limitations or modifications to the requested parameters, and/or an initial set of location data if immediately available. In some examples, this step may also involve the MME 506 confirming that it has the necessary resources and permissions to fulfill the location tracking request for the specified subscriber. The use of “4b” in the step label, corresponding to the “3b” in the previous step, may further emphasize that these steps are part of a specific sub-sequence or alternative flow within the broader monitoring process.

The diagram continues with step 516, showing a message from the HSS 504 to the SCEF 502 labeled “5—Monitoring Response”. This communication may represent the HSS 504 relaying the successful monitoring setup confirmation back through the network hierarchy. The HSS 504 may aggregate any additional information or metadata relevant to the monitoring request before passing it to the SCEF 502. In some scenarios, this step may also involve the HSS 504 updating its internal records to reflect the active monitoring status, which may be helpful for managing multiple concurrent location tracking requests across the network. This centralized management of monitoring statuses in the HSS 504 may contribute to more efficient handling of subsequent location queries or updates for the target subscriber.

Finally, step 518 depicts the last message in the setup sequence, from the SCEF 502 to the LI System 202, labeled “6—Monitoring Response”. This message may provide the LI System 202 with confirmation that its monitoring request has been successfully processed and that location information will be provided according to the specified parameters. The response may include details such as a monitoring session identifier, the expected format of location data, and/or any relevant security tokens or authentication information for future communications related to this monitoring session. This confirmation step may help ensure that the LI System 202 and the network are in agreement regarding the monitoring parameters and expectations, potentially reducing errors or misunderstandings in subsequent location information exchanges.

In some examples, the method may further comprise determining that the target subscriber is in an idle state such that the access and mobility management function provides last known location information. This determination of the subscriber's idle state may be implemented through various techniques within the network architecture. For instance, the Access and Mobility Management Function (AMF) 212 may maintain a state machine for each connected subscriber, tracking transitions between active and idle states based on signaling activity and/or data transfer patterns. The AMF 212 may employ timers to automatically transition a subscriber to an idle state after a predefined period of inactivity. Additionally, the system may utilize context-aware algorithms that consider factors such as time of day, historical usage patterns, and/or subscriber preferences to predict and manage idle states more accurately. In some scenarios, the idle state determination may be augmented by information from other network elements, such as the gNodeB, which may report on radio connection status. The system may also implement a hybrid approach where short-term inactivity triggers a light sleep mode, while prolonged inactivity leads to a deeper idle state, each with different implications for location information availability. When a location request is received for a subscriber in an idle state, the AMF 212 may initially respond with the last known location information stored in its database. This location data may be tagged with a timestamp and confidence level to indicate its recency and reliability. The system may offer configurable thresholds for what constitutes acceptable “last known” information, allowing flexibility based on the specific requirements of the requesting entity. In some implementations, if the last known location is deemed too old or imprecise, the AMF 212 may initiate a paging procedure to wake the subscriber device and obtain fresh location data. This paging process may be optimized to minimize network signaling and battery drain on the subscriber device. The system may also support a deferred location request model, where requests for idle subscribers are queued and processed when the subscriber next becomes active. Furthermore, the idle state handling may be integrated with mobility management procedures, ensuring that location tracking remains effective even as idle subscribers move between different coverage areas. The system may employ predictive algorithms to estimate potential locations of idle subscribers based on their last known trajectory and historical movement patterns. In more advanced implementations, machine learning models may be used to continuously improve the accuracy of idle state location estimation. These various techniques for handling idle state subscribers and providing last known location information may be dynamically selected and combined based on factors such as network conditions, subscriber profiles, and/or specific requirements of the lawful interception request.

In some examples, the location information may comprise one of cell global identity or evolved cell global identity. The system may employ various techniques to determine and provide this location information within the context of lawful interception requests. Cell Global Identity (CGI) and Evolved Cell Global Identity (E-CGI) represent different levels of granularity in identifying a subscriber's location within a mobile network. The system may dynamically select between these formats based on factors such as network capabilities, subscriber equipment, and/or the specific requirements of the lawful interception request. For instance, in a 5G network environment, the Access and Mobility Management Function (AMF) 212 may request location information from the gNodeB 710, which may respond with the most appropriate identifier based on the current network configuration. The system may also support a hierarchical approach to location reporting, where it initially provides a broader E-CGI and then refines to a more specific CGI if requested or if network conditions permit. In some implementations, the location information may be augmented with additional data such as timing advance measurements, received signal strength indicators, and/or angle of arrival data to provide a more comprehensive understanding of the subscriber's position. The system may also incorporate adaptive algorithms that adjust the precision of location reporting based on factors like subscriber mobility, network load, and/or privacy settings. For subscribers in areas with dense small cell deployment, the system may offer sub-cell level positioning by combining CGI or E-CGI data with Wi-Fi or Bluetooth Low Energy (BLE) beacon information. In scenarios where higher accuracy is desired, the system may integrate CGI or E-CGI data with GPS coordinates obtained from the user equipment, when available and permissible. The location information provision may also be time-aware, offering historical CGI or E-CGI data along with timestamps to reconstruct a subscriber's movement pattern. For roaming subscribers, the system may translate between different cell identification formats to ensure consistent reporting across network boundaries. Additionally, the system may implement a fallback mechanism where, if CGI or E-CGI cannot be determined, it provides alternative location identifiers such as tracking area codes or service area identities. The location reporting system may also offer configurable privacy filters that allow network operators to balance lawful interception requirements with subscriber privacy concerns, potentially masking certain digits of the CGI or E-CGI in less critical scenarios. In more advanced implementations, machine learning algorithms may be employed to predict and pre-fetch likely CGI or E-CGI information based on subscriber behavior patterns, potentially reducing response times for location requests.

In some examples, the method may further comprise authenticating the lawful interception system using a bearer token. This authentication process may be implemented through various mechanisms within the network architecture shown in FIG. 5. The Service Capability Exposure Function (SCEF) 502 may act as the primary interface for authenticating the Lawful Interception (LI) System 202. The bearer token may be generated using industry-standard protocols such as OAuth 2.0 or JSON Web Tokens (JWT). These tokens may contain encrypted information about the LI System's identity, permissions, and expiration time. The SCEF 502 may implement a token validation service that checks the integrity and authenticity of the bearer token with each request from the LI System 202. This validation may involve verifying the token's signature, checking its expiration, and confirming that the permissions encoded in the token match the requested operation. The system may support token refresh mechanisms, allowing the LI System 202 to obtain new tokens without repeated full authentication processes. Token revocation lists may be maintained by the SCEF 502 to immediately invalidate compromised or outdated tokens. The authentication system may implement multi-factor authentication for initial token issuance, combining the bearer token with additional security measures such as client certificates or IP address validation. The SCEF 502 may offer token scope management, allowing fine-grained control over which network resources and operations each token can access. This may enable the system to issue tokens with limited capabilities for specific monitoring tasks. The bearer token authentication may be integrated with the network's overall identity and access management system, ensuring consistent security policies across different interfaces and services. The SCEF 502 may implement rate limiting based on token attributes, preventing potential abuse of the system by restricting the number of requests a single token can make within a given time frame. The authentication system may support delegated access, allowing a master LI System to obtain tokens on behalf of subordinate systems or users, with appropriate auditing and control mechanisms. Token-based authentication may also facilitate easier integration with federated identity systems, enabling seamless authentication across multiple network operators or jurisdictions in complex lawful interception scenarios.

In some examples, the method may further comprise encrypting communications between the network exposure function and the lawful interception system using Transport Layer Security (TLS). This encryption process may be implemented through various mechanisms within the network architecture shown in FIG. 5. The Service Capability Exposure Function (SCEF) 502 may act as the primary interface for secure communications with the Lawful Interception (LI) System 202. The system may support multiple versions of TLS, including TLS 1.2 and TLS 1.3, to accommodate different security requirements and compatibility needs. The SCEF 502 may implement perfect forward secrecy by using ephemeral Diffie-Hellman key exchange algorithms, enhancing the security of each session. Certificate pinning techniques may be employed to prevent man-in-the-middle attacks by verifying that the server's certificate matches a pre-defined set of valid certificates. The system may support mutual TLS authentication, where both the SCEF 502 and the LI System 202 present certificates to verify their identities. This may provide an additional layer of security beyond basic server authentication. The SCEF 502 may implement Online Certificate Status Protocol (OCSP) stapling to efficiently check the revocation status of certificates without introducing additional latency. The encryption system may support various cipher suites, allowing for flexibility in choosing the most appropriate combination of key exchange, encryption, and hashing algorithms based on security requirements and computational resources. The SCEF 502 may implement session resumption mechanisms to reduce the overhead of full TLS handshakes for repeated connections from the same LI System 202. This may improve performance while maintaining security. The system may support the use of Hardware Security Modules (HSMs) for key storage and cryptographic operations, providing an additional layer of protection for sensitive key material. The SCEF 502 may implement TLS session tickets or session IDs to enable efficient reconnection without the need for a full handshake. This may be particularly helpful in scenarios with frequent, short-lived connections. The encryption system may support the use of elliptic curve cryptography for key exchange and digital signatures, potentially offering equivalent security with smaller key sizes compared to RSA. The SCEF 502 may implement strict TLS configuration policies, such as disabling older, vulnerable protocols and cipher suites, to maintain a high security posture. These policies may be dynamically updated based on emerging security best practices and threat intelligence.

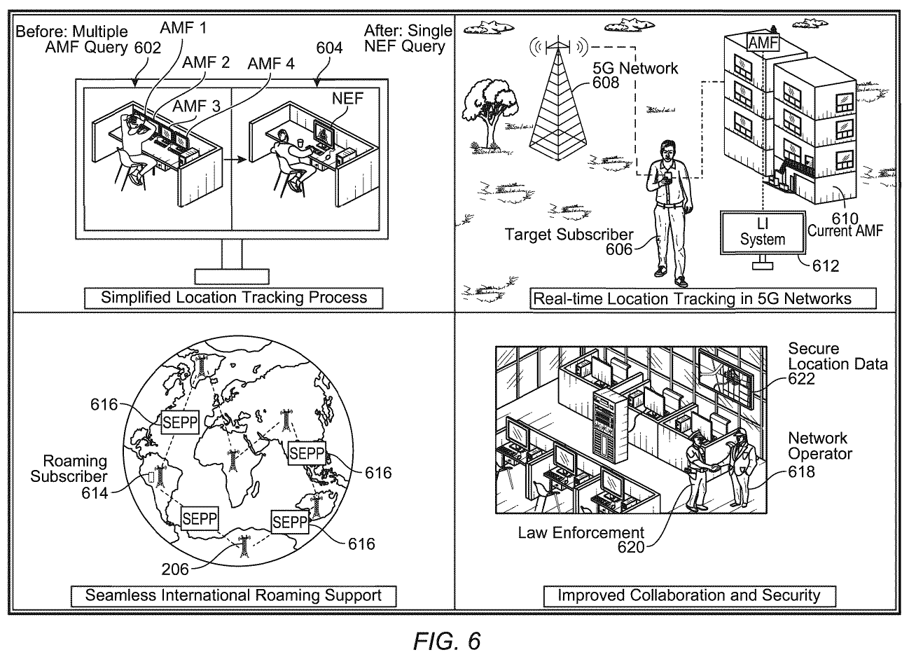

FIG. 6 shows an example multi-panel illustration depicting various aspects of an improved location information retrieval process for lawful interception in communication networks. The figure comprises four panels, each highlighting different facets of the technique and its potential benefits.

The top-left panel of FIG. 6 presents a split-screen view contrasting two scenarios. On the left side, it shows a frustrated police officer 602 surrounded by multiple computer screens labeled “AMF 1,” “AMF 2,” “AMF 3,” and so on. The officer is depicted holding his head in his hands, suggesting a sense of frustration or overwhelm. This representation may illustrate a scenario where location queries for lawful interception purposes involve querying multiple Access and Mobility Management Functions (AMFs) individually. On the right side of the split screen, the same officer is shown looking relaxed and pointing to a single screen labeled “NEF.” A large arrow points from the left side to the right side of this panel. The left side is labeled “Before: Multiple AMF Queries 602,” while the right side is labeled “After: Single NEF Query 604.” A text box at the bottom of this panel states “Simplified Location Tracking Process.” This visual comparison may serve to illustrate the potential benefits of centralizing location queries through a Network Exposure Function (NEF), which may streamline the process and reduce the workload for law enforcement personnel. The contrast between the two sides of this panel may suggest improvements in efficiency and ease of use for lawful interception systems.

The top-right panel of FIG. 6 illustrates a scenario depicting real-time location tracking in a 5G or subsequent generation network environment. In the background, it shows a 5G cell tower 608, representing the network infrastructure. In the foreground, a person holding a smartphone, labeled as “Target Subscriber 606,” is depicted. Above the person, a dotted line connects to the cell tower 608, and another dotted line connects to a building labeled “Current AMF 610.” A third dotted line extends from the AMF 610 to a computer screen labeled “LI System 612.” This visual representation may illustrate the flow of location information from the target subscriber's device through the network infrastructure to the lawful interception system. The use of dotted lines may suggest the wireless and/or logical connections between these components. A text box in this panel states “Real-time Location Tracking in 5G Networks,” emphasizing the capability of the system to provide up-to-date location information in advanced mobile network environments.

The bottom-left panel of FIG. 6 focuses on illustrating support for international roaming scenarios. It shows a globe with multiple cell towers across different continents, indicating a global network infrastructure. A dotted line connects one tower to another, passing through a box labeled “SEPP 616” (Security Edge Protection Proxy). A smartphone labeled “Roaming Subscriber 614” is shown next to one of the towers. This visual representation may illustrate how the location tracking system may handle subscribers who are roaming internationally. The inclusion of the SEPP 616 in the communication path may suggest that security and privacy measures are maintained even in cross-border scenarios. A text box in this panel states “Seamless International Roaming Support,” highlighting the system's capability to provide consistent location tracking services regardless of the subscriber's geographical location.

The bottom-right panel of FIG. 6 depicts a scenario showcasing improved collaboration and security in the lawful interception process. It illustrates a network operations center with servers and screens, representing the technical infrastructure. In the foreground, a person in a suit labeled “Network Operator 618” is shown shaking hands with a person in a police uniform labeled “Law Enforcement 620.” Behind them, a large screen showing a map with a blinking dot is visible, labeled “Secure Location Data 622.” This visual representation may suggest enhanced cooperation between network operators and law enforcement agencies, facilitated by the improved location tracking system. The depiction of a map with a blinking dot may illustrate the real-time nature of the location data being shared. A text box in this panel states “Improved Collaboration and Security,” emphasizing the potential for better coordination and data protection in lawful interception processes.

In some examples, the location information may comprise one of current location, last known location, deferred location, or periodic location reporting. This diverse range of location information types may be implemented through various mechanisms within the network architecture depicted in FIG. 6. The system may utilize different location determination methods depending on the type of information requested and the current state of the target subscriber 606. For current location, the Access and Mobility Management Function (AMF) 610 may initiate an immediate location request to the serving cell tower 608. This process may involve techniques such as Cell ID, Observed Time Difference of Arrival (OTDOA), or Assisted GPS (A-GPS) to determine the subscriber's position with varying degrees of accuracy. Last known location information may be retrieved from a cached database within the AMF 610 or other network elements. This cache may be updated at regular intervals or based on specific events such as cell handovers or periodic location area updates. The system may implement a time-to-live mechanism for cached locations to help ensure that outdated information is not used. Deferred location reporting may be utilized in scenarios where immediate location information is not available or when the subscriber is temporarily unreachable. In this case, the AMF 610 may queue the location request and fulfill it when the subscriber becomes available or when certain conditions are met. The system may support complex trigger conditions for deferred reporting, such as entering or leaving specific geographic areas. Periodic location reporting may involve scheduling regular updates at specified intervals. The AMF 610 may implement adaptive intervals that change based on the subscriber's movement patterns or network conditions. The system may also support hybrid reporting modes that combine different types of location information. For example, it may provide last known location immediately followed by periodic updates once the subscriber becomes active. The accuracy and granularity of location information may be dynamically adjusted based on factors such as the capabilities of the serving network, the subscriber's device, and any privacy settings or regulatory requirements. The LI System 612 may specify preferences for location information types through API parameters, allowing for flexible and context-aware location tracking.

In some examples, the method may be performed in a 5G or subsequent generation network. This network environment may offer various capabilities and features that enhance the location information retrieval process. The 5G network 608 shown in FIG. 6 may provide improved bandwidth and lower latency compared to previous generations, potentially enabling more frequent and precise location updates. The network may support network slicing, allowing dedicated resources for lawful interception activities. This may help in prioritizing location queries and responses, especially in high-traffic scenarios. The 5G or subsequent generation network may implement edge computing capabilities, bringing processing closer to the target subscriber 606. This may reduce response times for location requests and enable more complex location algorithms to be run locally. The network may support massive Machine-Type Communications (mMTC), which may be helpful for tracking a large number of IoT devices in addition to traditional mobile subscribers. Enhanced Mobile Broadband (eMBB) features of 5G and beyond may support high-definition video and augmented reality applications, potentially enabling visual tracking or context-aware location services. The network may implement advanced beamforming techniques, which may improve location accuracy in dense urban environments or indoor spaces. Ultra-Reliable Low-Latency Communication (URLLC) features may be utilized for critical tracking scenarios where immediate and reliable location information is essential. The 5G or subsequent generation network may support higher frequency bands, including millimeter wave (mmWave) spectrum, which may enable more precise location determination in some scenarios. The network may integrate with satellite systems more effectively, potentially improving location services in rural or remote areas. Advanced antenna technologies, such as Massive MIMO, may be leveraged to improve signal quality and coverage, potentially enhancing location accuracy. The network may support more sophisticated handover mechanisms, allowing for smoother tracking of subscribers moving between cells or network slices. The 5G or subsequent generation infrastructure may enable more advanced data analytics and machine learning algorithms to be applied to location data, potentially improving prediction and estimation capabilities.

In some examples, the method may further comprise providing location information for an international roaming scenario through a security edge protection proxy. This international roaming capability may be implemented through various mechanisms within the network architecture depicted in FIG. 6. The system may utilize the Security Edge Protection Proxy (SEPP) 616 to facilitate secure communication between the home network and visited networks when the roaming subscriber 614 is abroad. The SEPP 616 may act as a gateway for all signaling traffic, including location-related messages, between networks. It may implement protocol translation functions to handle differences in signaling protocols between networks of different generations or from different vendors. The SEPP 616 may support end-to-end encryption of sensitive information, such as subscriber identities and location data, to protect against eavesdropping or tampering during cross-border transmission.

In some examples, the method may further comprise paging the target subscriber such that current location information is obtained in response to the target subscriber being in an idle state. This paging process may be implemented through various mechanisms within the network architecture depicted in FIG. 6. The Access and Mobility Management Function (AMF) 610 may initiate a paging procedure when it receives a location request for a target subscriber 606 that is currently in an idle state. The paging message may be broadcasted across multiple cells or tracking areas where the subscriber was last known to be present. The system may implement intelligent paging algorithms that prioritize cells based on the subscriber's historical movement patterns and/or time of day. The AMF 610 may utilize different paging strategies depending on the urgency of the location request. For non-urgent requests, it may employ a gradual paging technique that starts with a small area and expands if no response is received. The system may incorporate power-saving considerations into the paging process, using discontinuous reception (DRX) cycles to minimize battery drain on the target subscriber's device. The AMF 610 may coordinate with the User Equipment (UE) to implement a fast-wake mechanism that allows the device to quickly respond to paging messages without fully exiting its idle state. The paging process may be integrated with the network's congestion control mechanisms to prevent overload situations in high-traffic scenarios. The system may support differentiated paging priorities, allowing lawful interception requests to be given higher precedence over standard location queries. The AMF 610 may implement a fallback mechanism where, if paging fails to elicit a response, it provides the last known location along with a confidence score based on the age of the information. The paging process may be optimized for different types of devices, such as IoT sensors or wearables, which may have different power and connectivity characteristics compared to standard smartphones. The system may incorporate machine learning algorithms to continuously improve the efficiency of the paging process based on historical success rates and network conditions.

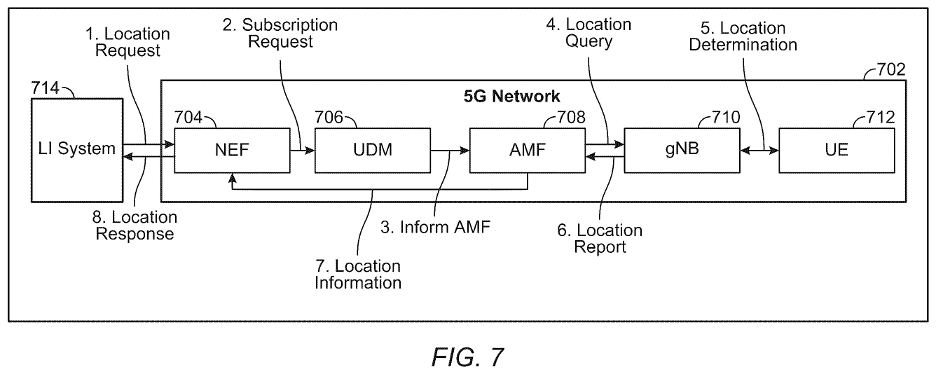

FIG. 7 shows an example detailed schematic diagram of the lawful interception location tracking process in a 5G or subsequent generation network environment. The diagram illustrates a comprehensive view of certain components and their interactions within the system, showing the flow of information for location tracking purposes. The figure depicts a large rectangular box representing the entire 5G network 702, which encompasses several smaller boxes arranged in a logical flow from left to right, each representing different network functions and elements involved in the location tracking process.

Inside the 5G network 702, the leftmost box represents the Network Exposure Function (NEF) 704. The NEF 704 serves as the primary interface between external systems, such as the Lawful Interception (LI) system, and the core network components. This function is responsible for exposing network capabilities and subscriber information in a controlled and secure manner, acting as a gateway for location requests and responses. To the right of the NEF 704, the diagram shows the Unified Data Management (UDM) function 706. The UDM 706 plays a central role in managing subscriber data and is responsible for maintaining up-to-date information on which Access and Mobility Management Function (AMF) is currently serving each subscriber. This centralized technique for storing subscriber-AMF associations offers advantages in streamlining the location information retrieval process.

In the center of the 5G network 702, the diagram depicts the Access and Mobility Management Function (AMF) 708. The AMF 708 is responsible for managing the mobility and connectivity of mobile devices within the network, and has direct access to the most current location information for subscribers. To the right of the AMF 708, the figure shows a gNodeB (gNB) 710, which represents the radio access network component in 5G systems. The gNB 710 is directly involved in determining the physical location of mobile devices through various positioning methods. At the rightmost position within the 5G network 702, the diagram includes a box representing the User Equipment (UE) 712, which is the target subscriber's mobile device for which location information is being requested.

Outside the 5G network 702, on the far left of the diagram, FIG. 7 shows a box labeled LI System 714. This represents the external Lawful Interception system that initiates location information requests and receives the resulting data. The LI System 714 is operated by law enforcement agencies or other authorized entities seeking to obtain location information for specific target subscribers. The positioning of the LI System 714 outside the 5G network 702 emphasizes its role as an external requestor interfacing with the network through standardized protocols and interfaces.

The diagram uses solid arrows to illustrate the flow of information between the various components, with each arrow labeled to indicate the type of information being exchanged. The first arrow, labeled “1. Location Request,” extends from the LI System 714 to the NEF 704, representing the initial request for location information. This triggers a series of interactions within the network to fulfill the request. The second arrow, labeled “2. Subscription Request,” goes from the NEF 704 to the UDM 706, indicating a request to subscribe to location updates for the target subscriber. The third arrow, “3. Inform AMF,” connects the UDM 706 to the AMF 708, showing that the UDM informs the appropriate AMF about the location request.

The fourth arrow in the sequence, labeled “4. Location Query,” extends from the AMF 708 to the gNB 710, which represents the AMF requesting more precise location information from the radio access network. A bidirectional arrow labeled “5. Location Determination” connects the gNB 710 and the UE 712, illustrating the process of determining the UE's location, which involves various positioning methods and signaling between the network and the mobile device. The sixth arrow, “6. Location Report,” goes from the gNB 710 back to the AMF 708, carrying the determined location information. The seventh arrow, labeled “7. Location Information,” connects the AMF 708 to the NEF 704, showing the transfer of the obtained location data back through the network hierarchy. Finally, the eighth arrow, “8. Location Response,” extends from the NEF 704 to the LI System 714, representing the delivery of the requested location information to the external system.

This comprehensive diagram illustrates how the various network functions collaborate to efficiently retrieve and deliver location information in response to lawful interception requests. The centralized role of the UDM 706 in maintaining subscriber-AMF associations eliminates the need for the LI System to query multiple AMFs to locate a target subscriber, reducing network traffic and improving response times. The use of the NEF 704 as an intermediary provides an additional layer of security and abstraction between the external LI System and the core network components, allowing for better control over information exposure and access. The direct involvement of the gNB 710 in the location determination process enables more accurate and up-to-date location information to be provided, particularly in scenarios where precise positioning is required.

In some examples, the location information retrieval technique may be adapted to handle various types of requests beyond subscriptions. The system may be configured to process one-off queries, series of requests, bulk orders, and/or batch operations without necessarily creating a long-term subscription. These alternative request types may offer flexibility in how location information is obtained and utilized by lawful interception systems or other authorized entities. For instance, a one-off query may be helpful in scenarios where immediate location information is desired for a specific target subscriber without the need for ongoing updates. This type of request may be processed through the Network Exposure Function (NEF) 704, which may route the query to the appropriate Access and Mobility Management Function (AMF) 708 via the Unified Data Management (UDM) function 706, similar to the subscription process but without establishing a persistent monitoring arrangement. Series requests may involve a predetermined number of location updates over a specified time period, which may be useful for tracking a target's movements during a specific event or investigation. The system may handle these requests by temporarily storing the series parameters and executing the location queries at the defined intervals. Bulk orders may allow for simultaneous location requests for multiple target subscribers, potentially improving efficiency in large-scale operations. In this case, the NEF 704 may batch the requests and distribute them to the relevant AMFs 708 in parallel, coordinating the responses to deliver a comprehensive set of location data to the requesting entity. Batch operations may involve processing a group of location requests at scheduled times or based on certain triggers, which may be helpful for periodic reporting or event-driven location tracking. The system may implement queue management techniques to handle these batch requests efficiently, prioritizing and executing them according to predefined rules or operational requirements. Additionally, the location retrieval technique may support dynamic queries that adjust based on real-time conditions or specified criteria. For example, the frequency of location updates may automatically increase if a target subscriber enters a designated area of interest or if their movement patterns match certain predefined parameters. This adaptive technique may help balance the need for timely information with resource utilization and privacy considerations. The system may also offer options for combining different request types, such as initiating a subscription after a series of one-off queries reveals a pattern of interest, or transitioning from bulk orders to individual tracking based on specific triggers. By supporting this range of request types and operational modes, the location information retrieval technique may provide a versatile toolset for lawful interception and authorized monitoring activities, adaptable to various operational needs and scenarios within the bounds of legal and regulatory frameworks.

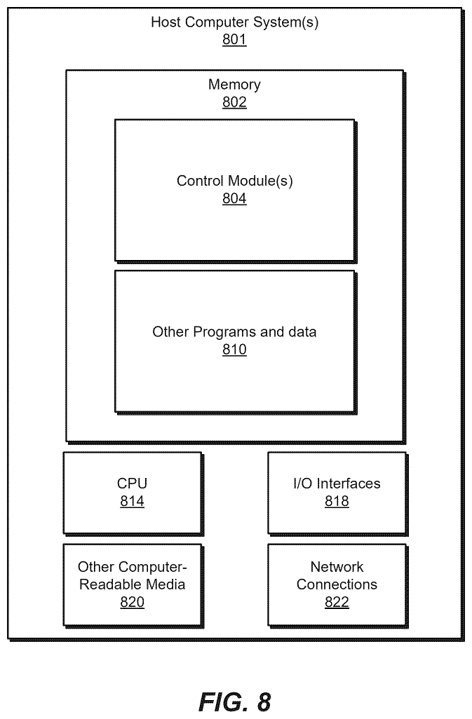

FIG. 8 shows a system diagram that describes an example implementation of a computing system(s) for implementing embodiments described herein. The functionality described herein may be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 8 illustrates an example of underlying hardware on which such software and functionality may be hosted and/or implemented.

In particular, shown is example host computer system(s) 801. For example, such computer system(s) 801 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 801 may include memory 802, one or more central processing units (CPUs) 814, I/O interfaces 818, other computer-readable media 820, and network connections 822.

Memory 802 may include one or more various types of non-volatile and/or volatile storage technologies. Examples of memory 802 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 802 may be utilized to store information, including computer-readable instructions that are utilized by CPU 814 to perform actions, including those of embodiments described herein.

Memory 802 may have stored thereon control module(s) 804. The control module(s) 804 may be configured to implement and/or perform some or all of the functions of the systems or components described herein. Memory 802 may also store other programs and data 810, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 822 are configured to communicate with other computing devices to facilitate the functionality described herein. In various embodiments, the network connections 822 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 818 may include a video interface, other data input or output interfaces, or the like. Other computer-readable media 820 may include other types of stationary or removable computer-readable media, such as removable flash drives, external hard drives, or the like.

The various embodiments described above may be combined to provide further embodiments. These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, by a Network Exposure Function (NEF), a request from a Lawful Interception System (LIS) to obtain location information for a target subscriber;
transmitting, by the NEF in response to receiving the request, a subscription request to a Unified Data Management (UDM) function such that the UDM function subscribes to location information for the target subscriber;
identifying, by the UDM function based on the subscription request, a specific Access and Mobility Management Function (AMF) currently serving the target subscriber;
informing, by the UDM function, the identified specific AMF of the subscription request;
receiving, by the NEF from the identified specific AMF and in response to informing the identified specific AMF, location information for the target subscriber; and
providing, by the NEF, the received location information to the LIS.

2. The method of claim 1, further comprising authenticating the LIS using a bearer token.

3. The method of claim 1, wherein the subscription request comprises a service-based interface using HTTP or HTTPS protocols.

4. The method of claim 1, wherein the location information comprises one of current location, last known location, deferred location, or periodic location reporting.

5. The method of claim 1, further comprising determining that the target subscriber is in an idle state such that the AMF provides last known location information.

6. The method of claim 1, wherein the UDM function updates the specific AMF whenever the target subscriber registers with a different AMF.

7. The method of claim 1, wherein the subscription request specifies a maximum number of location reports such that the subscription is terminated when the maximum number is reached.

8. The method of claim 1, wherein the location information comprises one of Cell Global Identity (CGI) or Evolved CGI (E-CGI).

9. The method of claim 1, further comprising encrypting communications between the NEF and the LIS using Transport Layer Security (TLS).

10. The method of claim 1, wherein the subscription request specifies continuous location reporting for the target subscriber.

11. The method of claim 1, wherein the NEF integrates with the LIS using a 3GPP-defined Application Programming Interface (API).

12. The method of claim 1, wherein the method is performed in a 5G or subsequent generation network.

13. The method of claim 12, wherein the method is performed in a 5G network.

14. The method of claim 1, further comprising providing location information for an international roaming scenario through a Security Edge Protection Proxy (SEPP).

15. The method of claim 1, further comprising paging the target subscriber such that current location information is obtained in response to the target subscriber being in an idle state.

16. The method of claim 1, wherein the UDM function:
stores an International Mobile Subscriber Identity (IMSI) for the target subscriber; or
stores a subscription detail comprising at least one of allowed service, Quality of Service (QoS) parameter, or access restriction.

17. A non-transitory computer-readable medium that has instructions stored thereon that, when executed by at least one physical computing processor, cause a computing device to perform operations comprising:
receiving, by a Network Exposure Function (NEF), a request from a Lawful Interception System (LIS) to obtain location information for a target subscriber;
transmitting, by the NEF in response to receiving the request, a subscription request to a Unified Data Management (UDM) function such that the UDM function subscribes to location information for the target subscriber;
identifying, by the UDM function based on the subscription request, a specific Access and Mobility Management Function (AMF) currently serving the target subscriber;
informing, by the UDM function, the identified specific AMF of the subscription request;
receiving, by the NEF from the identified specific AMF and in response to informing the identified specific AMF, location information for the target subscriber; and
providing, by the NEF, the received location information to the LIS.

18. The non-transitory computer-readable medium of claim 17, wherein the subscription request comprises a service-based interface using HTTP or HTTPS protocols.

19. A system comprising:
at least one physical computing processor of a computing device; and
a non-transitory computer-readable medium that has instructions stored thereon that, when executed by the at least one physical computing processor, cause the computing device to perform operations comprising:
receiving, by a Network Exposure Function (NEF), a request from a Lawful Interception System (LIS) to obtain location information for a target subscriber;
transmitting, by the NEF in response to receiving the request, a subscription request to a Unified Data Management (UDM) function such that the UDM function subscribes to location information for the target subscriber;
identifying, by the UDM function based on the subscription request, a specific Access and Mobility Management Function (AMF) currently serving the target subscriber;
informing, by the UDM function, the identified specific AMF of the subscription request;
receiving, by the NEF from the identified specific AMF and in response to informing the identified specific AMF, location information for the target subscriber; and
providing, by the NEF, the received location information to the LIS.

20. The system of claim 19, wherein the subscription request comprises a service-based interface using HTTP or HTTPS protocols.
